(19) United States
(12) Patent Application Publication
(10) Pub. No.: US 2018/0034162 A1
(43) Pub. Date: Feb. 1, 2018

(54) FLEXIBLE PRINTED ANTENNA DEVICES, METHODS, AND SYSTEMS

(71) Applicant: Honeywell International Inc., Morris Plains, NJ (US)

(72) Inventors: Glen Backes, Golden Valley, MN (US); Alan Cornett, Golden Valley, MN (US); Logan Zvolena, St. Paul, MN (US)

(21) Appl. No.: 15/225,426

(22) Filed: Aug. 1, 2016

(51) Int. Cl. H01Q 21/06; H01Q 1/24; H01Q 1/08

(52) U.S. Cl. CPC H01Q 21/061; H01Q 1/085; H01Q 1/241

(57) ABSTRACT

Flexible printed antenna devices, methods, and systems are described herein. One device includes a conductive element having a pattern of printable conductive ink applied onto an ink-receptive, non-conductive substrate to form an antenna having multiple antenna elements, wherein the substrate is flexible allowing the multiple antenna elements to be rolled or folded over on each other and a connector element formed from a pattern of printable conductive ink applied to the ink-receptive, non-conductive substrate configured to receive and connect to a signal transmission and/or reception device using a non-contact coupling element.

### TECHNICAL FIELD

The present disclosure relates to flexible printed antenna devices, methods, and systems.

### BACKGROUND

An antenna device can be used for the transmission and reception of radio frequency (RF) and microwave signals to a reception device or signal transmission, for example, cellular telephones, global positioning systems (GPS), and wireless data networks.

In some instances, there is a need for on-the-fly set up of RF electronics and transmitting/receiving equipment to establish a communication link for the exchange of data and/or information. However, the use of an antenna poses a particular problem, especially for relatively low frequencies, which require larger antennas. For example, such antennas can be large or have a shape that is awkward to transport. The antenna may be rigid and incapable of being collapsed. Or, in some instances, the antenna may be a telescoping variety which can collapse into a smaller form factor, but can be susceptible to damage if the tube shapes forming the sections of the telescoping antenna are bent or deformed.

In some instances, when connecting the antenna to the reception device for signal transmission, attaching wires directly to the antenna may not be a mechanically viable option and may cause rips and tears in the structure. Furthermore, application and removal of the antenna can be problematic in some applications, for example, where the antenna is fixedly attached to the transmitting/receiving device.

### BRIEF DESCRIPTION OF THE DRAWINGS

FIG. 1 illustrates an example of a flexible printed antenna device according to one or more embodiments of the present disclosure.

FIG. 2 illustrates an example of a flexible printed antenna system according to one or more embodiments of the present disclosure.

### DETAILED DESCRIPTION

Flexible printed antenna devices, methods, and systems are described herein. A flexible printed antenna device as disclosed herein can be used in military applications (where users of one communication device may be trying to communicate with another communication device, discreetly). In such applications, embodiments of the present disclosure may be beneficial due to their ability to be highly portable and have a discreet form factor that can be affixed to many surfaces that may not draw attention to the used.

Embodiments of the present disclosure can also be used in commercial applications, where portability or small form factor may be beneficial, among other applications. A commercial application may, for example, be where a user is in a remote or difficult to access area and may need to communicate from that location to others about a visual assessment of a problem or to receive instructions on how to effectuate a repair.

Further, embodiments of the present disclosure can be used in personal applications, where portability, ease of assembly and connection, or small form factor may be beneficial, among other applications. For example, a hiking group may want to communicate with a base camp and therefore, embodiments having a small form factor when being stored can be beneficial. Additionally, a personal user may want an antenna that can be placed on a surface such that it does not detract from the ambiance of a room.

In some applications, there is a need for on-the-fly set up of radio frequency (RF) electronics and transmitting/receiving equipment to establish communications for the exchange of data and information using a flexible printed antenna system. This on-the-fly set up can, for example, be useful in the contexts described above where a user may be in a remote or difficult to reach area (inside the difficult to access area of a power plant, for example. In such applications, the ability to move a communication system, having an embodiment of the present disclosure, to the area in a small, portable form factor and/or its easy assembly with few parts to assemble, may be very helpful.

Flexible printed antenna systems using embodiments of the present disclosure can include a conductive element printed onto an ink-receptive non-conductive substrate to form an antenna. The conductive element can include a pattern of printable conductive ink that is applied to an ink-receptive non-conductive substrate to form an antenna that has multiple antenna elements. In some embodiments, the non-conductive substrate is constructed out of a flexible material that can be adhered to a flat non-conductive surface. This can, for example, allow for easy application and removal of the antenna.

One device embodiment includes a conductive element having a pattern of printable conductive ink applied onto an ink-receptive, non-conductive substrate to form an antenna. In such an embodiment, the antenna can have multiple antenna elements, wherein the substrate is flexible allowing the multiple antenna elements to be rolled or folded over on each other.

Device embodiments can also include a connector element formed from a pattern of printable conductive ink applied to the ink-receptive, non-conductive substrate. In such an embodiment, the connector element is configured to receive and connect to a signal transmission and/or reception device using a non-contact coupling element.

The flexible printed antenna device embodiments can be generally planar, allowing, for example, for rolling, folding, and low profile placement on surfaces when the antenna is deployed. In some embodiments, the antenna device can include a rectangular or other suitable shaped non-conductive substrate wherein the antenna array can be spread out on the shape to increase its surface area.

For example, the antenna can have several branches emanating from a trunk (the trunk connected to the connector element), like a tree design. In some embodiments, the antenna can be a spiral emanating outward or inward from a point on the non-conductive substrate, or a wavy pattern (wherein the connector element is connected at one end, the pattern traverses up and down or side to side from this end and terminates at a second end). Such configurations can allow for a considerably longer antenna to be used than a straight or loop type antenna.

In some embodiments, the antenna device has a first surface for adhering the antenna to a flat non-conductive surface. The first surface of the antenna can, for example, be conducive to holding an electrostatic charge and this charge can be used to adhere the antenna device to a surface, such as a wall, whiteboard, door, surface of a vehicle or structure, window, etc.

In various embodiments, the conductive ink can be opaque allowing the user and others to view the antenna. In some embodiments, the conductive ink can be transparent or applied in the thin manner, for example, to make detection of the antenna difficult.

In some embodiments, the ink-receptive, non-conductive substrate is transparent. Such embodiments may be harder to detect, which may be beneficial in military or personal applications, among others.

In various embodiments, the ink-receptive, non-conductive substrate has a coating that allows for releasable application and removal of the antenna device to the flat non-conductive surface. For example, the device may be coating in a releasable adhesive that allows the device to be applied and removed from a surface without damage to the surface and/or the device.

In some embodiments, the antenna device may be constructed to be rigid in one direction, allowing the device to be free standing (without support from surface of another object placed parallel to the antenna's surface. Such embodiments may allow the antenna device to be positioned on a surface, such as a table or car hood, such that the antenna is angled away from the surface (e.g., wherein the antenna device is curved or folded such that it is perpendicular to the surface of the table, in at least one dimension).

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

The figures herein follow a numbering convention in which the first digit or digits correspond to the drawing figure number and the remaining digits identify an element or component in the drawing. As will be appreciated, elements shown in the various embodiments herein can be added, exchanged, and/or eliminated so as to provide a number of additional embodiments of the present disclosure.

As used herein, “a” or “a number of” refers to one or more. In addition, as will be appreciated, the proportion and the relative scale of the elements provided in the figures are intended to illustrate the embodiments of the present invention, and should not be taken in a limiting sense.

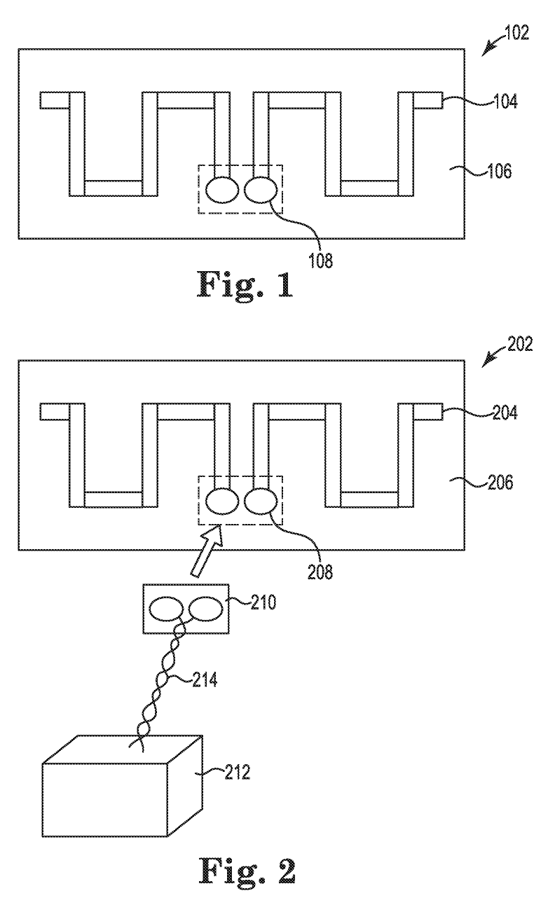

FIG. 1 illustrates an example of a flexible printed antenna device according to one or more embodiments of the present disclosure. As shown in the embodiment of FIG. 1, antenna device embodiments can include a conductive element 104 having a pattern of printable conductive ink applied onto an ink-receptive, non-conductive substrate 106 to form an antenna 102 having multiple antenna elements, and a connector element 108.

The flexible printed antenna device 102 can be attached (e.g., adhered) to a flat non-conductive surface and used for the transmission and reception of RF or other electromagnetic signals. Example flat non-conductive surfaces can include a windshield inside or outside a vehicle, near a window of a vehicle or a structure such as a building, a table, a whiteboard, or any other suitable flat, non-conductive surfaces.

The flexible printed antenna device 102 is formed of a conductive element 104 and a connector element 106. The flexible printed antenna device 102 is created by having a pattern of printable conductive ink applied onto an ink-receptive, non-conductive substrate 106 to form an antenna having multiple antenna elements (e.g., branches of a tree type design, a spiral having multiple looped portions, a wavy pattern having a multiple back and forth and/or up and down connected elements).

In various embodiments, the ink-receptive, non-conductive substrate 106 can be flexible allowing the multiple antenna elements to be rolled or folded over on each other. As discussed above, this can be beneficial in allowing for ease of portability, among other benefits.

The flexible printed antenna device 102 is formed from a pattern of printable conductive ink applied to the ink-receptive, non-conductive substrate. Such an embodiment can allow for the antenna to be printed on a printer at an office or the home of a user, in some embodiments. By allowing such printing techniques, the shape of the substrate and/or pattern can be customized by the user or designer of the antenna to suit a specialized purpose (e.g., a form factor to fit a particular backpack or for a particular activity, such as a hike needing special communication requirements) or desired shape (e.g., a user wanting a design that matches a shape on a wall in a bedroom). In such embodiments, the ink-receptive, non-conductive substrate can be paper or plastic substrates, for example.

The connector element 108 is configured to receive and connect to a signal transmission and/or reception device using a non-contact coupling element (e.g., 210 of FIG. 2).

In the embodiment of FIG. 1, the antenna device is generally planar and has a first surface (in FIG. 1, the first surface would be the back of the paper on which FIG. 1 is printed) for adhering the antenna to a flat non-conductive surface, allowing for easy application and removal of the antenna from a flat non-conductive surface, such as a window. The first surface is conductive to holding an electrostatic charge and can be adhered to the flat non-conductive surface using electrostatic charge. Additionally, in some embodiments, the non-conductive substrate can have a coating on the first surface, similar to a decal, which allows for releasable application and removal of the antenna device to the flat non-conductive surface.

While the conductive ink that is printed onto the ink-receptive, non-conductive substrate 106 can be opaque, the other areas of the substrate can be transparent or nearly transparent, in some embodiments as described herein.

An antenna structure can be created by applying a printable conductive ink onto an ink-receptive transparent substrate with a coating similar to a window decal that is adhered by adhesive or electrostatic charge. Such embodiments would allow easy application and removal of the antenna from a window. In some embodiments, the non-conductive substrate could be a polyester substrate, which would allow the substrate to be non-opaque, which may be desirable, in some applications.

In one example, the flexible printed antenna device 106 includes a conductive element, which is made by printing the conductive element onto an ink-receptive substrate using conductive ink. The flexible printed antenna device 102 also includes a connector element, which is made by printing the connector element onto the ink-receptive substrate using conductive ink, wherein the connector element is formed to allow for communication of signals between the connector and the conductive elements.

Embodiments of the present disclosure can be constructed as a conductive element including a pattern of printable conductive ink to form an antenna, wherein the pattern of printable conductive ink comprises at least one conductive line of conductive material.

In some cases, the equipment forming the signal transmission and/or reception needs to be set up quickly, easily, and/or unobtrusively, and in some applications, in a low observable fashion. Methods can be employed to reduce the visual cross section of the opaque conductive portion of the antenna material to improve the design from a low observable standpoint.

For example, some embodiments use many thin, parallel conductive lines that are connected together at their ends (such as the parallel portions of the element 104 in FIG. 1) to emulate an electrically wide bar-shaped antenna. In some such embodiments, the spacing of the thin lines may need to be sufficiently small to allow coupling of the signals.

In some embodiments, the antenna structure may have the visual appearance of an automotive rear windshield wires used for frost removal or also in a radio windshield antenna. In another embodiment, the conductive element can be a single line that runs once or multiple times (each time around the perimeter forms one of the multiple antenna elements) around the perimeter of the ink-receptive substrate.

In some embodiments, the ink-receptive substrate can be a material that can hold an electrostatic charge, such as polyester. In other embodiments, a coating can be applied to the ink-receptive substrate that allows for a first surface of the ink-receptive substrate to hold an electrostatic charge, allowing for the first surface to adhere to the flat non-conductive surface using the electrostatic charge.

In other embodiments, the flexible printed antenna device can be adhered to a flat non-conductive surface using mechanical attachment items such as suction cups that would be attached to a first surface of the ink-receptive substrate. In other embodiments, a light adhesive coating, such as a low-tack, pressure-sensitive adhesive, could be applied to a first surface of the ink-receptive substrate, allowing for the flexible printed antenna device to adhere to a flat non-conductive surface of an object (e.g., surface of a car, building, structure, etc.) and then be removed without damage to the surface of the object and/or the surface of the antenna device.

As discussed herein, in some embodiments, the conductive element is formed by printing a conductive ink onto an ink-receptive substrate. In other embodiments, double sided tape or adhesive can be used to adhere a conductive film onto a non-conductive substrate, such as clear, polyester sheet or by printing a conductive ink onto the conductive film, wherein the conductive ink forms an antenna having multiple antenna elements, and wherein the sheet is flexible, allowing the multiple antenna elements to be rolled and/or folded over on each other.

In another example, long thin pieces of conductive wire could be glued onto a flexible substrate to form an antenna. In further example, a conductive fabric or wire can be sewn into a piece of textile, wherein the textile would be adhered onto an electrostatic film which would adhere to a flat non-conductive surface using an electrostatic charge.

FIG. 2 illustrates an example of a flexible printed antenna system according to one or more embodiments of the present disclosure. As shown in FIG. 2, the system can include a first conductive element 204 having a pattern of printable conductive ink applied onto an ink-receptive, non-conductive substrate 206 to form an antenna 202 having multiple antenna elements.

The antenna 202 also includes a connector element 208 that connects to a second conductive element having a pattern of printable conductive ink applied onto an ink-receptive, non-conductive substrate to form a non-contact coupling element 210.

In discussed above, the ink-receptive, non-conductive substrate 206 can be flexible allowing the multiple antenna elements to be rolled or folded over on each other.

Connector element 208 is formed from a pattern of printable conductive ink applied to ink-receptive, non-conductive substrate 206 which is configured to connect to a signal transmission and/or reception device 212 using a non-contact coupling element 210. As discussed above, the antenna can be printed on a printer and as such, the connector element can be designed to interface with a particularly shaped coupling element 210, thereby allowing embodiments to be customized to devices that a user may already possess, but may not have a suitable antenna (e.g., the antenna provided by a manufacturer is not portable).

The antenna system could be customized, for example, through use of a computing device having a processor and memory with instructions stored in the memory and executable by the processor to allow a user to design a specific shape for an antenna and/or connector element. Design instructions can then be sent to a printing device that can print the one or more customized designs on a non-conductive substrate using conductive ink. Upon receiving the instructions, the printer prints the customized antenna and/or connector element.

A non-contact coupling element 210 connects a signal transmission and/or reception device 212 to the connector element 208, wherein the coupling element 210 and its connection with the connector element 208 allows communication of signals to be transmitted and/or received by the transmission and/or reception device 212 to be transmitted or received via the antenna device 202. One benefit of using a connector element and a coupling element is that the antenna device can be placed and left in place while the transmission and/or receiving device can coupling element are removed.

Further, in some embodiments, the non-contact coupling element 210 is connected to the signal transmission and/or reception device 212 using wires 214, wherein the wires attach to the non-contact coupling element. However, in some embodiments, the connectivity may be wireless and signals can be passed between the coupling element 210 and the transmission and/or reception device 212, wirelessly.

In some embodiments, the antenna can include a battery that can be used to power the communication via the antenna to and/or from the transmission and/or reception device. Such embodiments may be beneficial where it may not be practical to have a power source available in or attached to the transmission or reception device.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A flexible printed antenna device, comprising:
a conductive element having a pattern of printable conductive ink applied onto an ink-receptive, non-conductive substrate to form an antenna having multiple antenna elements, wherein the substrate is flexible allowing the multiple antenna elements to be rolled or folded over on each other; and
a connector element formed from a pattern of printable conductive ink applied to the ink-receptive, non-conductive substrate configured to receive and connect to a signal transmission and/or reception device using a non-contact coupling element.

2. The flexible printed antenna device of claim 1, wherein the antenna device is planar.

3. The flexible printed antenna device of claim 1, wherein the antenna device has a first surface for adhering the antenna to a flat non-conductive surface.

4. The flexible printed antenna device of claim 3, wherein the first surface is conductive to holding an electrostatic charge and wherein the first surface can be adhered to the flat non-conductive surface using electrostatic charge.

5. The flexible printed antenna device of claim 1, wherein the conductive ink is opaque.

6. The flexible printed antenna device of claim 1, wherein the ink-receptive, non-conductive substrate is transparent.

7. The flexible printed antenna device of claim 1, wherein the ink-receptive, non-conductive substrate has a coating that allows for releasable application and removal of the antenna device to the flat non-conductive surface.

8. A system, comprising:
a first conductive element having a pattern of printable conductive ink applied onto an ink-receptive, non-conductive substrate to form an antenna having multiple antenna elements, wherein the substrate is flexible allowing the multiple antenna elements to be rolled or folded over on each other;
a connector element formed from a pattern of printable conductive ink applied to the ink-receptive non-conductive substrate configured to connect to a signal transmission and/or reception device using a non-contact coupling element; and
a second conductive element having a pattern of printable conductive ink applied onto an ink-receptive, non-conductive substrate to form a non-contact coupling element that connects the signal transmission and/or reception device to the connector element, wherein the coupling element couples an antenna signal to the signal transmission or reception device.

9. The system of claim 8, wherein the ink-receptive, non-conductive substrate has a coating that allows for releasable application and removal of the coupling element to the connector element.

10. The system of claim 8, wherein the coupling element is planar.

11. The system of claim 8, wherein the non-contact coupling element has a first surface for adhering the coupling element to the connector element.

12. The flexible printed antenna device of claim 11, wherein the first surface is conductive to holding an electrostatic charge and wherein the first surface can be adhered to the connector element using electrostatic charge.

13. The system of claim 8, wherein the non-contact coupling element is connected to the signal transmission and/or reception device using wires.

14. The system of claim 13, wherein the wires attach to the non-contact coupling element.

15. The system of claim 8, wherein the conductive element receives and transmits radio frequency and microwave signals.

16. A method, comprising:
printing a conductive element onto an ink-receptive substrate using conductive ink; and
printing a connector element onto the ink-receptive substrate using conductive ink, wherein the connector element is formed to allow for communication of signals between the connector and the conductive elements.

17. The method of claim 16, wherein the conductive element includes a pattern of printable conductive ink to form an antenna.

18. The method of claim 17, wherein the pattern of printable conductive ink comprises at least one thin conductive line.

19. The method of claim 16, wherein the ink-receptive substrate is a polyester substrate.

20. The method of claim 16, wherein printing a conductive element onto an ink-receptive substrate using conductive ink forms an antenna having multiple antenna elements.
